(19) United States
(12) Patent Application Publication
(10) Pub. No.: US 2002/0081485 A1
(43) Pub. Date: Jun. 27, 2002

(54) Non-aqueous rechargeable battery for vehicles

(76) Inventors: Toshihiro Takekawa, Kanagawa-ken (JP); Ryuzo Uemura, Kanagawa-ken (JP); Fumio Munakata, Tokyo (JP); Yasuhiko Ohsawa, Kanagawa-ken (JP)

Correspondence Address: MCDERMOTT WILL & EMERY, 600 13TH STREET, N.W., WASHINGTON, DC, 20005-3096, US

(21) Appl. No.: 09/984,885

(22) Filed: Oct. 31, 2001

(30) Foreign Application Priority Data
Nov. 1, 2000 (JP) P2000-334529

(51) Int. Cl. H01M 4/48; H01M 4/50; H01M 4/52

(52) U.S. Cl. 429/60; 429/231.1; 429/231.2; 429/231.3; 429/224; 429/221; 429/231.5

(57) ABSTRACT

A non-aqueous rechargeable battery for a vehicle contains a positive electrode, which has a positive electrode active material having a capacity of 120 mAh/g or larger; and a negative electrode, which has a negative electrode active material having a capacity of 280 mAh/g or larger and a reversible rate of the capacity of 80% or more, wherein a ratio of a positive electrode capacity to a negative electrode capacity is set to 0.6 to 0.9. The non-aqueous rechargeable battery has a light weight and a high energy density.

### BACKGROUND OF THE INVENTION

1. Field of the Invention

The present invention relates to a non-aqueous rechargeable battery, more particularly to a non-aqueous rechargeable battery suitably available for an energy source for an electric vehicle (EV), a hybrid electric vehicle (HEV), and a fuel cell vehicle (FCV).

2. Description of the Related Art

Demands for portable electronic appliances such as a cellular phone, PDA (Personal Digital Assistant), a mobile personal computer, a videotape recorder and a digital camera have been increased in recent years. The increase of demands for these electronic appliances depends on the practical application of a non-aqueous rechargeable battery such as a lithium ion rechargeable battery used as an energy source. To achieve the long hour use of the electronic appliance and to downsize the same, a large battery capacity and a high energy density are required for the non-aqueous rechargeable battery.

On the other hand, reduction of exhaust gas emissions has been required in view of environmental conservation, and development of an electric vehicle (EV), a hybrid electric vehicle (HEV) and a fuel cell vehicle (FCV), which use an engine and/or a motor as a driving power source, has been progressed in place of current vehicles using a conventional combustion system of fuel oil (gasoline, diesel fuel). As a battery for these EV, HEV, and FCV, the use of the non-aqueous rechargeable battery such as a lithium ion battery has been examined. The non-aqueous rechargeable battery for vehicles is needed to have a large battery capacity to obtain a sufficient driving range. In other words, the battery is needed to have a higher energy density per a cell of the equal weight.

As described above, the battery for an electronic appliance is also designed so as to have a large battery capacity. However, if using this battery for a vehicle, it is difficult to achieve the driving range equivalent to that of a current vehicle using fuel oil due to insufficiency of an energy density. Specifically, a battery for a vehicle is required to have much larger capacity and higher energy density in comparison to those for an electronic appliance.

Conventionally, as a method for increasing an energy density, two basic methods have been used, such as a method in which an active material is improved for increasing the capacities of a positive electrode material and a negative electrode material themselves, and a method in which the amount of the active material to be filled into a battery of a limited volume is increased. Of the two methods, currently, development has been progressed with a great amount of efforts for the purpose of increasing the capacity of each electrode material itself.

However, at the time of the electrode materials thus obtained are combined to fabricate the battery, little study has been made until now concerning how much the performance enhancement of the each electrode material is reflected on the performance of the entire battery, as well as concerning how much the capacity of the obtained battery is in the case where the obtained high-performance materials are combined.

In the case of a battery for a portable electronic appliance, because of the small actuating current thereof, the necessary energy density can be sufficiently obtained if the positive electrode material capacity is made larger according to the conventional method. Accordingly, it has been unnecessary to examine the optimum combination between the positive electrode material and the negative electrode material.

### SUMMARY OF THE INVENTION

However, in the case of a battery for a vehicle, it is desired to have an energy density of 150 Wh/kg or larger in order to achieve a driving range equivalent to that of the conventional vehicle having a system in which fuel oil is combusted to obtain energy. As described above, the battery for a vehicle is required to have an extremely high energy density in comparison to that of a portable electronic appliance. Therefore, if only the conventional method is used, there is a limit to achieve the enhancement of an energy density of a battery for a vehicle.

Examinations have been made for a battery structure (Japanese Patent Laid-Open Publication H10-64587 (published in 1998)), in which the constitution of the negative electrode capacity relative to the positive electrode capacity is taken into consideration for the purpose of enhancing the battery quality and the battery performance and the performance of maintaining the operational state. Examinations have also been made for a battery structure (Japanese Patent Laid-Open Publication H11-265722 (published in 1999)), in which the ratio of the positive electrode capacity and the negative electrode capacity is taken into consideration for the purpose of improving a swelling property of the battery. However, there has been no study about a combination of a positive electrode capacity and a negative electrode capacity for the purpose of enhancing the energy density.

With such circumstances in mind, the inventors of this application found out a design guideline for effectively increasing the battery capacity and the energy density of a battery by optimizing the combination of a positive electrode material and the negative electrode material filled into a sealing case that has a limited volume. Then, the inventors have studied for a battery for a vehicle based on the guideline.

An object of the present invention is to provide a non-aqueous rechargeable battery for a vehicle, which has a lighter weight and a higher energy density than conventional one, based on the study for the optimum combination of a positive electrode material and a negative electrode material.

The inventors of this application found that a non-aqueous rechargeable battery having a light weight and a large capacity can be obtained by determining the optimum combination on the basis of the following four parameters, such as (1) capacity of a positive electrode active material, (2) capacity of a negative electrode active material, (3) reversible rate of a negative electrode capacity, and (4) ratio of a positive electrode capacity to a negative electrode capacity.

Specifically, according to the design guideline, the positive electrode capacity and the negative electrode capacity are balanced with each other so as not to have surplus or deficiency in the mutual capacities in a charge/discharge reaction. Also, the optimum range of the combination of a positive electrode active material and a negative electrode active material capable of obtaining the maximum capacity per unit weight of the active material is found out while considering the battery capacity reduction resulting from the irreversible capacity of the negative electrode. Furthermore, the positive electrode material and the negative electrode material are combined so as to obtain the predetermined energy density. Consequently, the capacity of the non-aqueous rechargeable battery can be made large to the maximum while suppressing the amount of the electrode active material to the minimum necessary amount.

In addition, recently, a layered-structure LiMnO₂ compound was found out (A. Robert and P. G. Bruce: Nature, Vol. 381 (1996), p. 499), which has a capacity of a positive electrode active material (about 270 mAh/g) larger than twice as large as that of the conventional spinel lithium manganese oxide complex.

Therefore, the optimum combining condition of a positive electrode material and a negative electrode material for obtaining a high energy density is determined, while considering the possibility of the use of the layered-structure LiMnO₂ compound having a large capacity as the positive electrode active material and the above four parameters. Thus, the non-aqueous rechargeable battery for a vehicle of the present invention is obtained.

A non-aqueous rechargeable battery according to an aspect of the present invention comprises a positive electrode which has a positive electrode active material having the capacity of 120 mAh/g or larger and a negative electrode which has a negative electrode active material having the capacity of 280 mAh/g or larger. The battery is also characterized in that a reversible rate of the negative electrode capacity is 80% or larger, and the ratio of the positive electrode capacity to the negative electrode capacity is 0.6 to 0.9.

According to the aspect of the present invention, the positive electrode capacity and the negative electrode capacity can be balanced with each other so as not to have surplus or deficiency in the mutual capacities in a charge/discharge reaction. Also, the combination of the positive electrode and the negative electrode capable of obtaining the maximum capacity per unit weight of the active material can be provided, while considering the battery capacity reduction resulting from the irreversible capacity of the negative electrode. Consequently a non-aqueous rechargeable battery which has energy density of 150 Wh/kg or larger can be provided.

### BRIEF DESCRIPTION OF THE DRAWINGS

FIG. 1 is a perspective view showing a structure example of a lithium ion rechargeable battery according to an embodiment of the present invention.

FIGS. 2A to 2D are graphs showing results of a simulation of battery capacities based on values of: positive electrode active material capacity (CP), negative electrode active material capacity (CN), reversible rate of a negative electrode capacity (RN), ratio between a positive electrode capacity and a negative electrode capacity ((CP·WP)/(CN·WN)). In this case, (CP·WP)/(CN·WN) is set to 0.8 and RN is set to 90%.

FIGS. 3A to 3D are graphs showing, similar to FIGS. 2A to 2D, results of a simulation of battery capacities, while taking into consideration the above-described four parameters.

FIGS. 4A to 4C are graphs also showing, similar to FIGS. 2A to 2D, results of a simulation of battery capacities, while taking into consideration the above-described four parameters.

FIGS. 5A to 5C are graphs showing, similar to FIGS. 2A to 2D, results of a simulation of battery capacities, while taking into consideration the above-described four parameters.

FIGS. 6A to 6C are graphs showing, similar to FIGS. 2A to 2D, results of a simulation of battery capacities, while taking into consideration the above-described four parameters.

FIGS. 7A to 7C are graphs showing, similar to FIGS. 2A to 2D, results of a simulation of battery capacities, while taking into consideration the above-described four parameters.

FIG. 8 is a table showing: (1) capacity of a positive electrode active material; (2) capacity of a negative electrode active material; (3) reversible rate of a negative electrode capacity; (4) ratio of a positive electrode capacity to a negative electrode capacity; and (5) energy density of a battery, in each battery of Examples 1 to 5 and Comparative examples 1 to 5 of the present invention.

### DETAILED DESCRIPTION OF THE EMBODIMENTS

Hereinafter, description will be made for an embodiment of a non-aqueous rechargeable battery of the present invention.

The non-aqueous rechargeable battery according to an embodiment of the present invention is the one where a round-shaped electrode device made by laminating a positive electrode, a separator and a negative electrode, are accommodated in a sealing case. The positive electrode is formed by coating slurry thinly and evenly on one surface of a metal foil serving as a collector. The slurry contains a positive electrode active material as a main component, a conducting agent and a binder. Similarly, the negative electrode is formed by coating slurry on one surface of a metal foil serving as a collector thinly and evenly. The slurry contains a negative electrode active material and a binder. Note that a plurality of plane positive electrodes and plane negative electrodes may be laminated on each other.

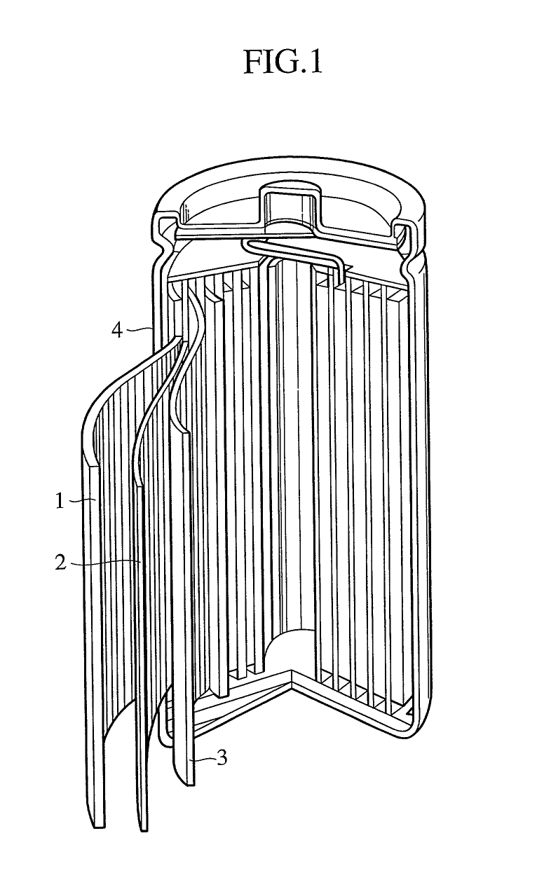

FIG. 1 shows a structure example of a lithium ion rechargeable battery, which is one of the examples of the non-aqueous rechargeable battery according to an embodiment of the present invention. As shown in FIG. 1, a device is constituted in such a manner that a positive electrode 1 formed by coating a positive electrode material containing a positive electrode active material on both surfaces of a metal foil collector, a negative electrode 3 similarly formed by coating a negative electrode material containing a negative electrode active material on both surfaces of a metal foil collector and a separator 2 interposed between the two electrodes are wound in a rolled shape, and the device thus obtained is accommodated in a sealing cylindrical case 4. Electrolyte (electrolytic solution) is filled in the case. Since the positive electrode 1 and the negative electrode 3 are wound in the rolled shape, a reaction area of the electrode can be enlarged to the maximum in the limited battery volume.

The non-aqueous rechargeable battery having a light weight and a large capacity according to the embodiment is obtained by determining the optimum combination of the positive electrode material and the negative electrode material, while taking into consideration the following four parameters in the above-described non-aqueous rechargeable battery, such as (1) capacity of the positive electrode active material, (2) capacity of the negative electrode active material, (3) reversible rate of the negative electrode capacity and (4) ratio of the positive electrode capacity to the negative electrode capacity.

The formula (f1) shown below is the one proposed by the inventors of the present invention and used for obtaining the battery capacity per unit weight based on the above-described four parameters. In the formula (f1), consideration is given also to a ratio of an additive such as a binder contained in the positive electrode and the negative electrode. Note that a value of an energy density of the battery is obtained by multiplying the battery capacity value per unit weight obtained by the formula (f1) by a rated voltage (3.5 to 4.2 V) of a use condition.

$$Battery capacity per unit weight [ mAh / g ] = \frac{CN \times RN \times ( CP \cdot WP ) / ( CN \cdot WN )}{\frac{1}{( 1 - Badd ( N ) )} + \frac{CN \times ( CP \cdot WP ) / ( CN \cdot WN )}{CP \times ( 1 - Badd ( P ) )}} \qquad ( f1 )$$

where

CP [mAh/g]: capacity of positive electrode active material (capacity per unit weight of the positive electrode active material);

CN [mAh/g]: capacity of negative electrode active material (capacity per unit weight of the negative electrode active material);

RN [%]: reversible rate of the negative electrode capacity (ratio of the amount of lithium ion de-intercalated from the negative electrode active material at the time of discharging to that intercalated in the negative electrode active material at the time of charging);

(CP·WP)/(CN·WN): ratio of the positive electrode capacity to the negative electrode capacity (ratio of a product obtained by multiplying the capacity of the positive electrode active material (CP) by the weight of the positive electrode active material in the positive electrode (WP) to a product obtained by multiplying the capacity of the negative electrode active material (CN) by the weight of the negative electrode active material in the negative electrode (WN));

Badd (N)[%]: addition rate of the binder or the like to the negative electrode; and

Badd (P)[%]: addition rate of the binder or the like to the positive electrode.

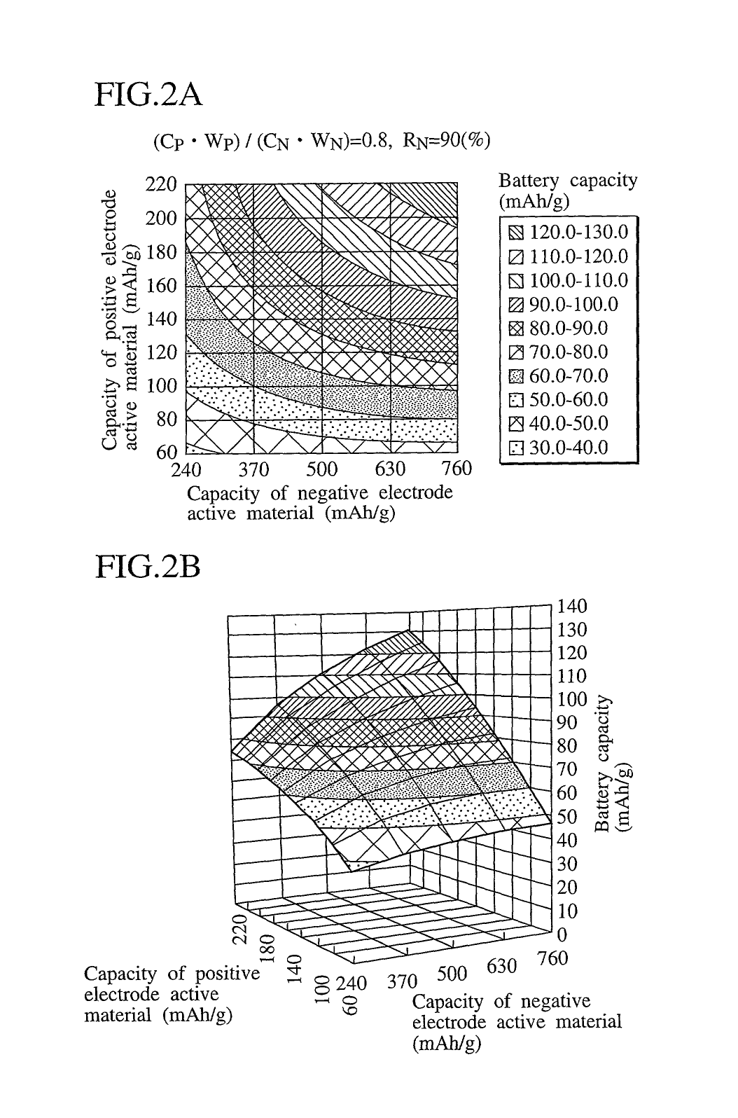

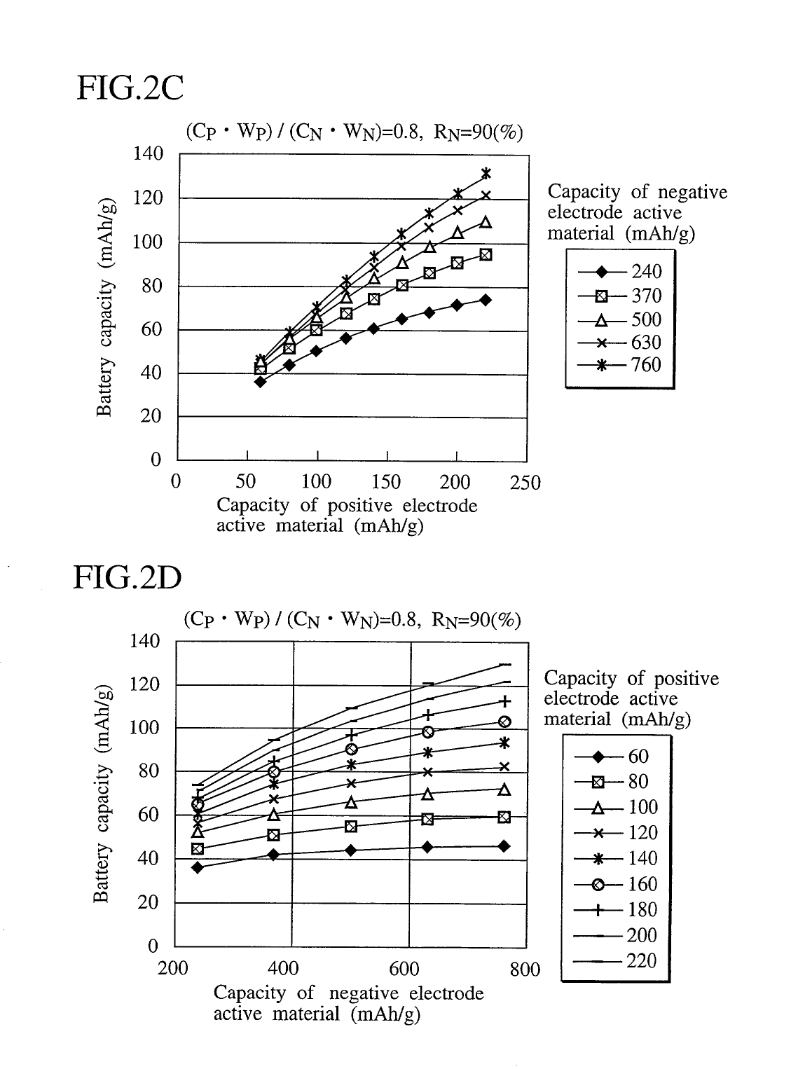

FIG. 2A is a graph showing a relation among the capacity of the positive electrode active material, the capacity of the negative electrode active material and the battery capacity per unit weight (hereinafter, referred to as battery capacity), which are simulated based on the above-described formula (f1). In this case, the ratio of the positive electrode capacity to the negative electrode capacity (CP·WP))/(CN·WN) is set to 0.8, and the reversible rate of the negative electrode capacity (RN) is set to 90%. FIG. 2B is a three dimensional graph showing the same contents as that of FIG. 2A. Furthermore, FIG. 2C and 2D also show the same contents. However, in FIG. 2C, the capacity of the positive electrode active material is taken as the horizontal axis, and the battery capacity is taken as the vertical axis. Also, in FIG. 2D, the capacity of the negative electrode active material is taken as the horizontal axis, and the battery capacity is taken as the vertical axis.

For example, as shown in FIGS. 2A to 2D, if intended to make the energy density of the battery be 150 Wh/kg or higher, the value of the battery capacity of 80 mAh/g or more serves as a standard. As shown in FIG. 2A, the capacity of the positive electrode active material necessary to obtain the battery capacity of the predetermined value or larger varies depending on a relation with the capacity of the negative electrode active material to be combined. For example, when the capacity of the positive electrode active material is 120 mAh/g, it is desirable that the capacity of the negative electrode active material is 630 mAh/g or larger. However, when the capacity of the positive electrode active material is 160 mAh/g, the capacity of the negative electrode active material of 370 mAh/g is sufficient. Also, when the capacity of the positive electrode active material is 200 mAh/g, the capacity of the negative electrode active material of 300 mAh/g is sufficient.

Specifically, when the ratio of the positive electrode capacity to the negative electrode capacity and the reversible rate of the negative electrode capacity are made to be constant values, as shown in FIGS. 2C and 2D, the larger the capacities of the positive electrode active material and the negative electrode active material become, the more the battery capacity increases. On the other hand, since the battery capacity is determined depending on the balance between the capacities of the positive electrode active material and the negative electrode active material, a condition range of the combination between the positive electrode material and the negative electrode material for obtaining the battery capacity of the predetermined value or more is rather expanded.

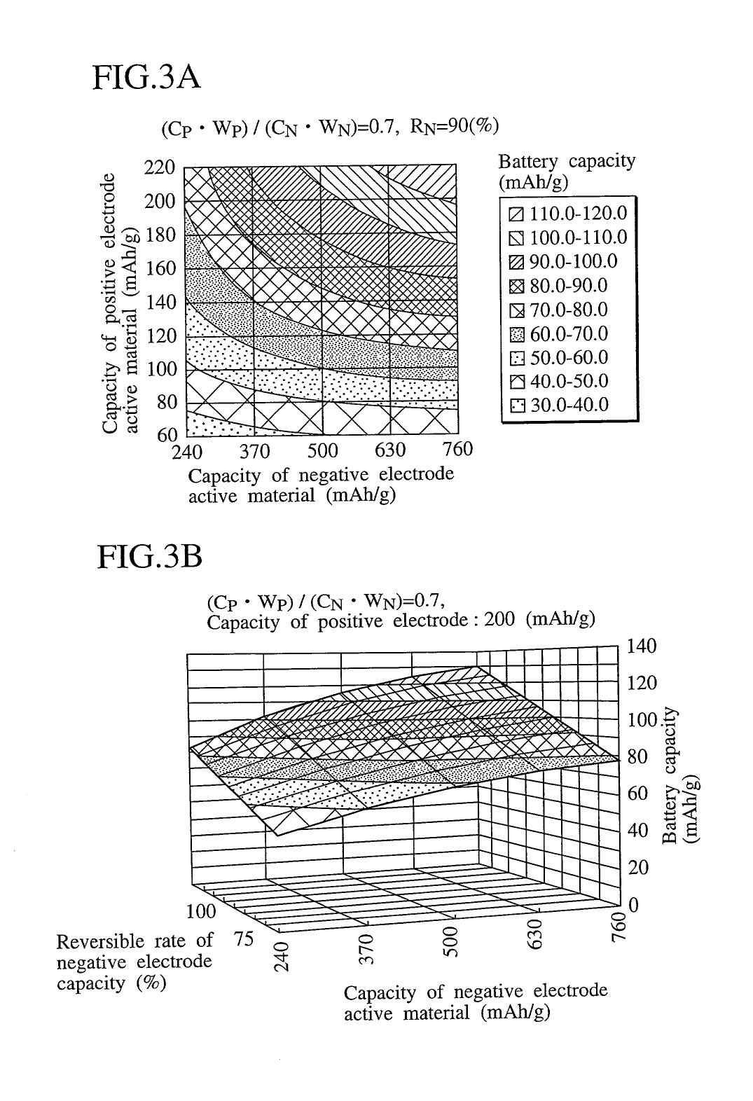

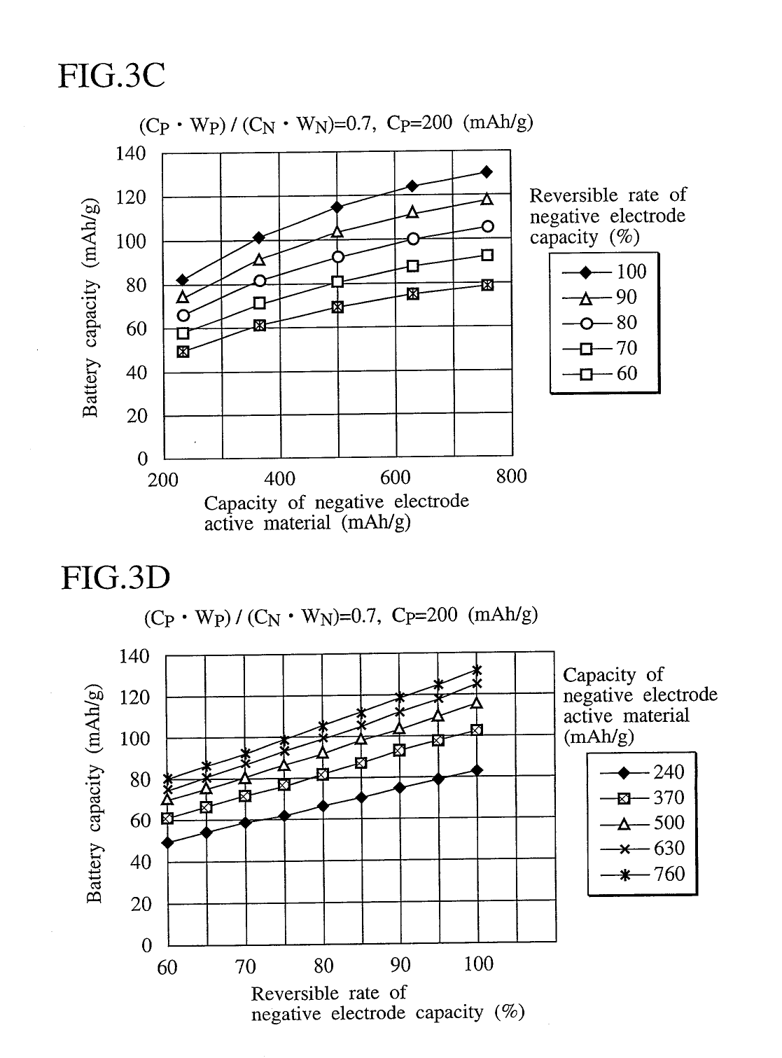

FIGS. 3A to 3D are graphs showing, similar to FIGS. 2A to 2D, results of a simulation of battery capacities. In FIG. 3A, (CP·WP)/(CN·WN) is set to 0.7, RN is set to 90%, and in FIGS. 3B to 3D, (CP·WP)/(CN·WN) is set to 0.7, CP is set to 200 mAh/g.

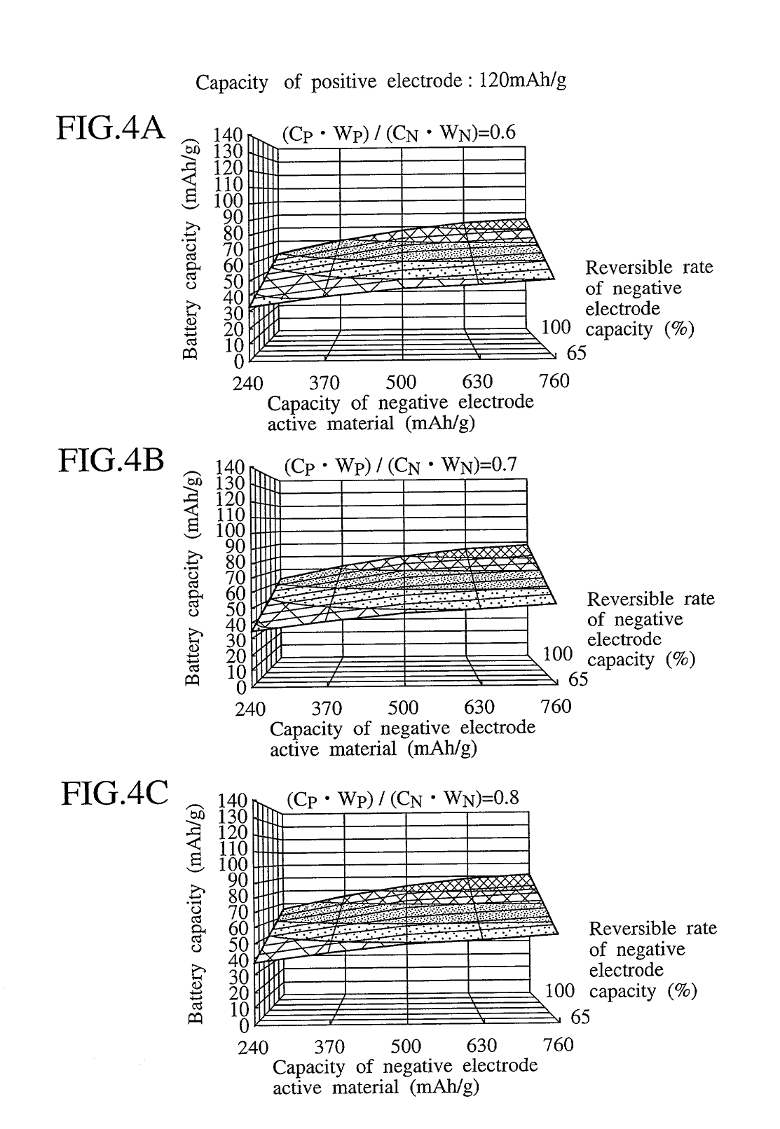

FIGS. 4A to 4C are graphs showing, similar to FIGS. 2A to 2D, results of a simulation of battery capacities on condition that CP is set to 120 mAh/g. Also, in FIGS. 4A, 4B and 4C, (CP·WP)/(CN·N) are set to 0.6, 0.7 and 0.8, respectively.

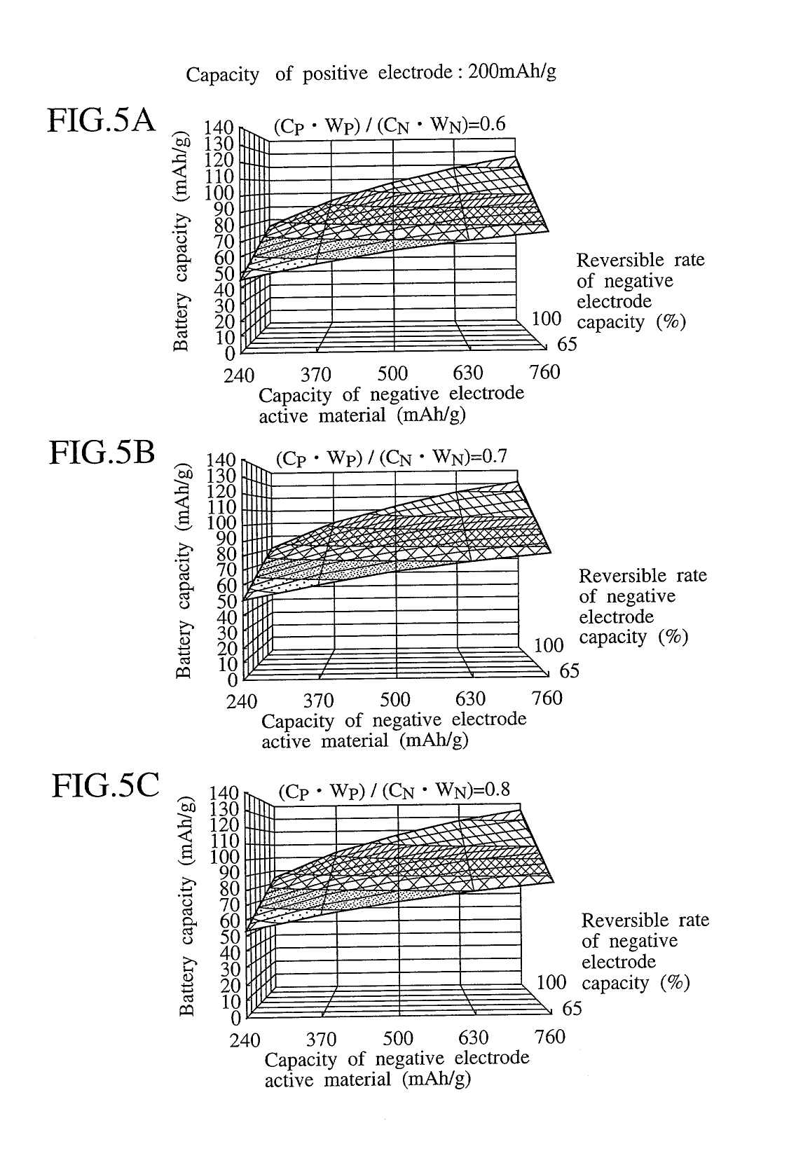

FIGS. 5A to 5C are graphs showing, similar to FIGS. 2A to 2D, results of a simulation of battery capacities on condition that the capacity of the positive electrode active material is set to 200 mAh/g. Also, in FIGS. 5A, 5B and 5C, (CP·WP))/(CN·WN) are set to 0.6, 0.7 and 0.8, respectively.

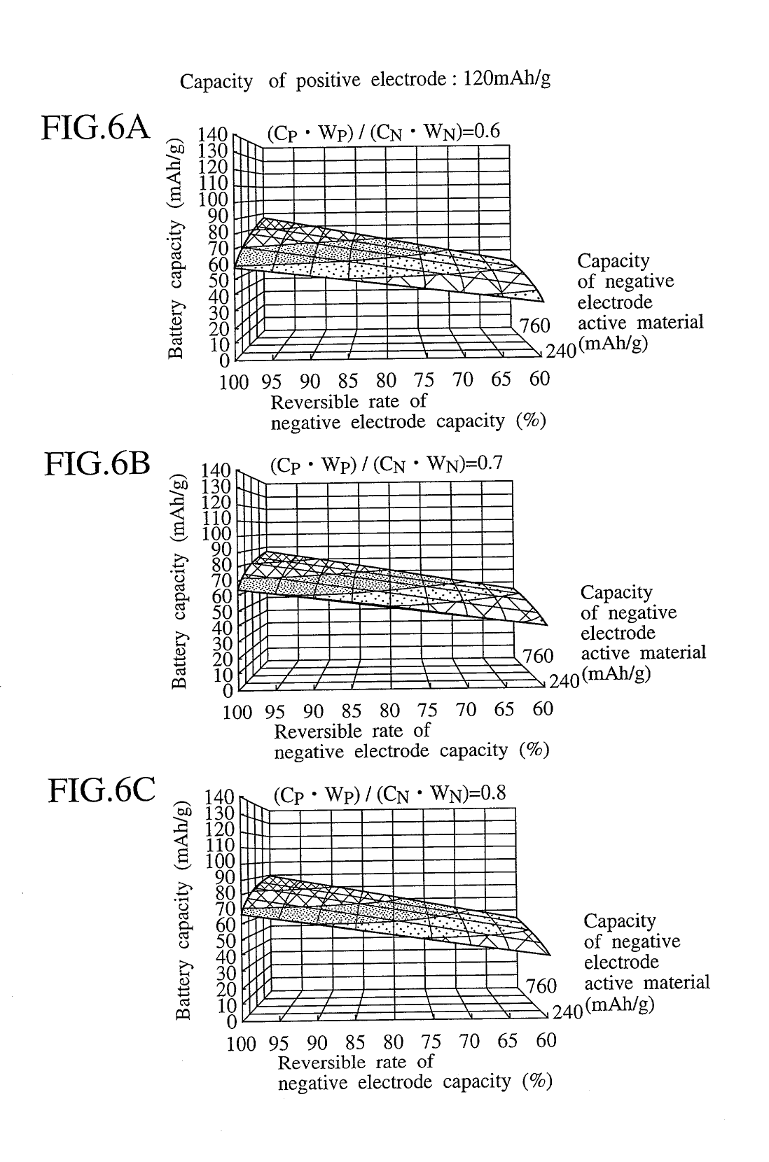

FIGS. 6A to 6C are graphs showing, similar to FIGS. 2A to 2D, results of a simulation of battery capacities on condition that CP is set to 120 mAh/g. Also, in FIGS. 6A, 6B and 6C, (CP·WP))/(CN·WN) are set to 0.6, 0.7 and 0.8, respectively.

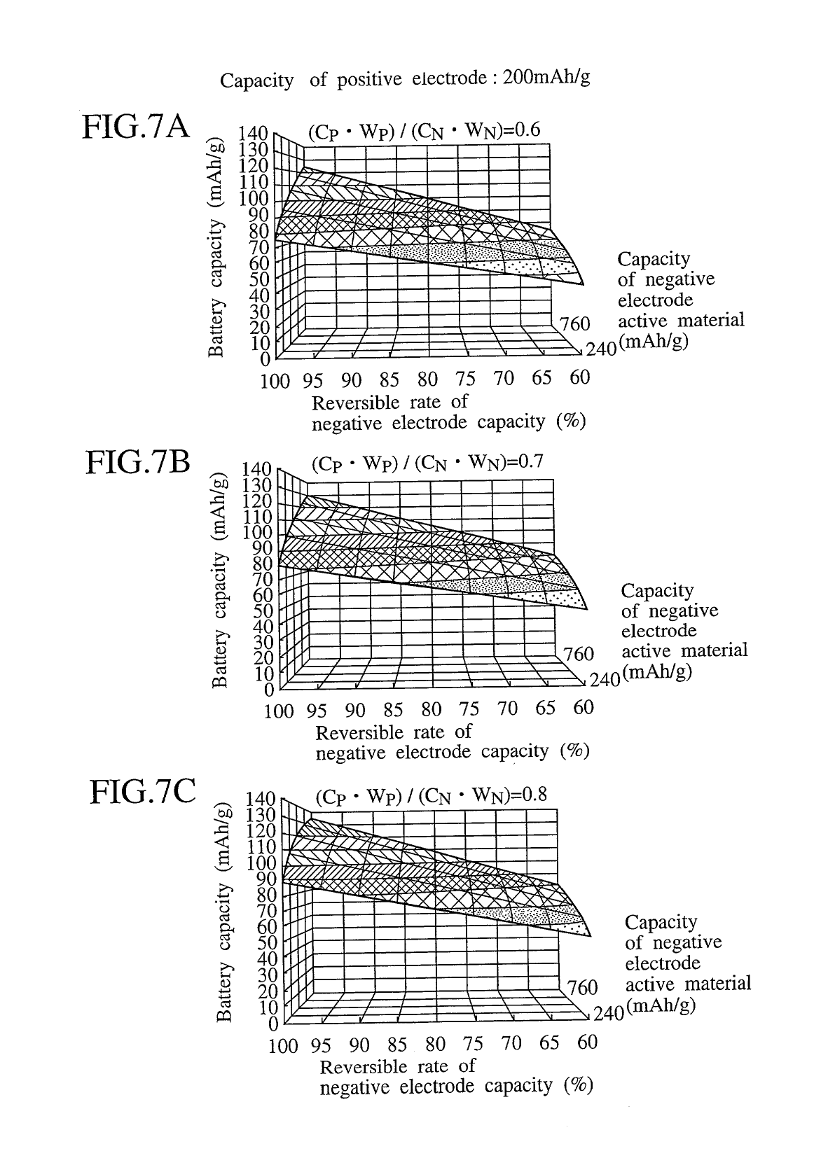

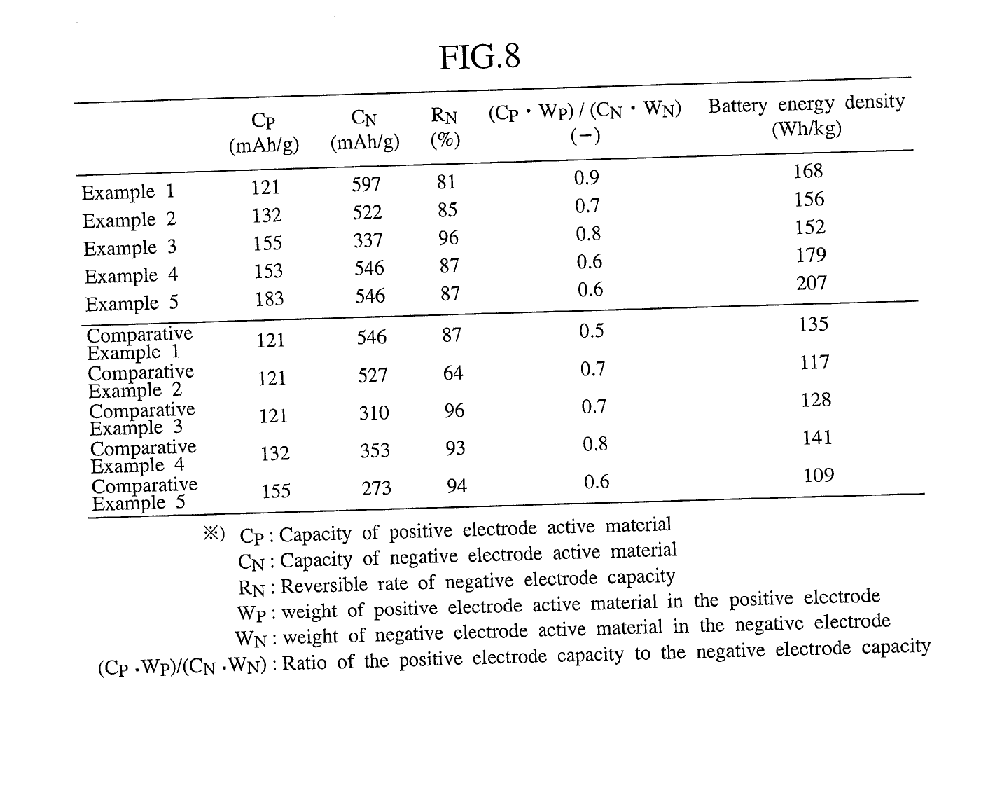

FIGS. 7A to 7C are graphs showing, similar to FIGS. 2A to 2D, results of a simulation of battery capacities on condition that CP is set to 200 mAh/g. Also, in FIGS. 7A, 7B and 7C, (CP·WP)/(CN·WN) are set to 0.6, 0.7 and 0.8, respectively.

Basically, as shown in FIG. 2C, it is preferable to use a material having a large capacity as the positive electrode active material in order to increase the battery capacity. Accordingly, a material having a capacity of 120 mAh/g or larger is preferably used as the positive electrode active material to obtain a non-aqueous rechargeable battery having a large capacity, more preferably a positive electrode active material having a capacity of 150 mAh/g or larger. Still more preferably, a positive electrode active material having a capacity of the positive electrode active material of 200 mAh/g or larger is used.

On the other hand, as shown in FIGS. 2A and 3A, it is necessary that the negative electrode has a capacity and a weight of the negative electrode active material corresponding to a capacity of the positive electrode active material in order to obtain the battery capacity of the predetermined value or more. It is desirable to suppress the weight of the negative electrode active material to be used as low as possible for the purpose of the weight saving of the battery. It is also preferable to use the negative electrode active material having a large capacity similar to the positive electrode active material. In order to suppress the weight of the negative electrode active material as low as possible, a material having the capacity of 280 mAh/g or larger is desirably used as the negative electrode active material.

Especially, the negative electrode active material having the capacity of 500 mAh/g or larger is more preferably used.

In addition, in graphs shown in FIGS. 2A to 2D, the reversible rate of the negative electrode is set to 90%. However, this reversible rate can be appropriately selected within the range of 80% to 95% by selecting the negative electrode active material to be used. As shown in FIGS. 6A to 6C and FIGS. 7A to 7C, if intended to increase the energy density of the battery, a material having a larger reversible rate is more advantageous and the reversible rate of 90% or more is preferable.

Furthermore, in the graphs shown in FIGS. 2A to 2D, the ratio between the positive electrode capacity and the negative electrode capacity is set to 0.8. However, it is desirable to make the negative electrode capacity larger relative to the positive electrode capacity. The reason is as follows. For example, in the case of a lithium ion rechargeable battery, if the negative electrode capacity is insufficient relative to the positive electrode capacity, the negative electrode can not completely intercalate lithium ions, sometimes causing a phenomenon that needle-shaped lithium crystal (dendrite crystal) is precipitated on the negative electrode surface. The precipitated lithium crystal frequently causes an internal short circuit and cycle deterioration. Especially, with respect to the battery for a vehicle used with a large capacity and a large current, anxiety may be created concerning a property for maintaining the battery performance and an operational stability of the battery.

In the Japanese Patent Laid-Open publication H10-64587, the ratio of the negative electrode capacity to the positive electrode capacity is set to 4 to 8 in view of the above-described aspect. However, such capacity ratio is not preferable because the weight of the active material, especially, the weight of the negative electrode material is needed to be large in order to increase the energy density.

There is a limit for the volume of the sealing case of the battery. Accordingly, if using the carbon material having a high bulk density as the negative electrode active material, the amount of the positive electrode active material to be filled for determining the battery capacity is relatively suppressed. In order to increase the energy density, it is desirable to fill the positive electrode material as much as possible in the limited volume. Therefore, the negative electrode active material having the large capacity is desirably used in order to reduce the volume of the negative electrode active material to be filled. That is, in order to satisfy a trade-off relation, in which the increase of the battery capacity is attempted, while suppressing the weights of both active materials to the minimum, the ratio of the positive electrode capacity to the negative electrode capacity is desirably set to 0.6 to 0.9. More desirably, the ratio is set to 0.7 to 0.8.

Since the capacities are mutually balanced between the positive electrode active material and the negative electrode active material, the necessary weight of the negative electrode corresponding to the positive electrode is largely varied depending on the capacity of the positive electrode active material, the capacity of the negative electrode active material, the ratio of the positive electrode capacity relative to the negative electrode capacity and the reversible rate of the negative electrode capacity. It is desirable that the capacity of the positive electrode active material to

However, for example, when the capacity of the positive electrode active material exceeds 160 mAh/g, it becomes easier to increase the capacity of the negative electrode active material than to increase the capacity of the positive electrode active material in order to further increase the battery capacity per unit weight. Accordingly, in order to increase the battery capacity while reducing the weight of the battery active material, it is desirable to find out the optimum range of each of the properties of the electrode materials such as the capacity of the positive electrode active material, the capacity of the negative electrode active material and the ratio of the capacities of the positive electrode and the negative electrode.

Hereinafter, a concrete example will be described concerning the optimum range of the combination between the positive electrode and the negative electrode, which satisfies the foregoing condition.

When using the negative electrode active material made of the carbon material having the capacity of 280 to 370 mAh/g, the optimum capacity range of the positive electrode active material is 160 mAh/g or larger. When the capacity of the negative electrode active material is further increased to 480 to 600 mAh/g, the optimum capacity range of the positive electrode active material expands to 120 mAh/g or larger. Also, when the carbon material having the capacity of 600 mAh/g or larger, which is obtained by a low-temperature baking (K. sato et al., Science, vol. 264 (1994), pp. 556-558) is used as the negative electrode active material, the optimum capacity range of the positive electrode active material further expands to 100 mAh/g or larger.

On the other hand, when the positive electrode active material having the capacity of 120 to 160 mAh/g is used, the optimum capacity range of the negative electrode active material is 400 mAh/g or more. When the capacity of the positive electrode active material is increased to 160 mAh/g or larger, the optimum capacity range of the negative electrode material is 280 mAh/g or larger. Similar to the case of the positive electrode, the optimum capacity range is more and more expanded.

Especially, when the positive electrode active material having the capacity of 120 mAh/g or larger and the negative electrode active material having the capacity of 280 mAh/g or larger are used in combination with having the capacity of 280 mAh/g or larger are used in combination with each other, the energy density of the battery of 150 Wh/kg or higher can be obtained. Thus, a non-aqueous rechargeable battery having the high energy density can be obtained. That is difficult to be obtained so far.

As shown in FIG. 2A, the optimum combinations between the positive electrode active material and the negative electrode active material for obtaining the equal battery capacity are located in a hyperbolic curve on a graph in which the capacity of the positive electrode active material and the capacity of the negative electrode active material are taken as the axes. Therefore, it becomes possible to obtain the optimum non-aqueous rechargeable battery by using the active materials having the desired capacity for the positive electrode and the negative electrode so as to obtain the targeted capacity.

Note that the positive electrode active material used for the positive electrode preferably contains the sufficient amount of lithium. For example, lithium-containing complex metal oxide, interlayer compound and the like, such as lithium cobalt oxide, lithium nickel oxide and lithium manganese oxide can be used.

Especially, if using a lithium manganese oxide material having a layered-structure shown by the following formula (f2), a positive electrode active material can be provided, which has a capacity (about 270 mAh/g) larger than that obtained by a spinel lithium manganese oxide (LiMn₂O₄) material or a lithium cobalt oxide (LiCoO₂) material.

LiₓMO_{2-δ} (f2)

(where M is one or more of materials selected from the group consisting of Co, Ni, Mn, Cr, Fe, V and Al; x is within the range of 0.4≦x≦1.1; and δ is within the range of 0≦δ≦0.1.) Especially, if using a lithium-deficient layered-structure lithium manganese oxide having x less than 1, a positive electrode active material, of which cycle durability is also good, can be provided.

On the other hand, as the negative electrode active material used for the negative electrode, any negative electrode materials used for the conventional non-aqueous rechargeable battery are usable. For example, lithium metal, lithium alloy, metal oxide such as SnSiO₃, metal nitride such as LiCoN₂ and carbon material capable of intercalating and de-intercalating lithium ions are usable.

As the carbon material to be used for the negative electrode, coke, natural graphite, artificial graphite, hard-graphitizable carbon (i.e. hard carbon) and the like can be enumerated. Especially, a carbonaceous material and a graphitized material obtained by carbonizing an organic material such as conjugated system resin, cellulose derivative, optional organic polymerized compounds, and petroleum pitch as a starting material by a baking method or the like are preferably used.

As the electrolytic solution, non-aqueous electrolytic solution is used, which is constituted with non-aqueous solvent and dissolved lithium salt as an electrolyte. As the lithium salt, conventionally known materials are used, such as LiClO₄, LiAsF₆, LiBF₄, LiCF₃SO₃ and Li(CF₃SO₂)₂N. As the non-aqueous solvent, though not particularly limited, carbonate, lactone, ether and the like can be enumerated. For example, solvents of ethylene carbonate, 1,2-dimethoxyethane, 1,2-diethoxyethane, tetrahydrofuran, 1,3-dioxolane, γ-butyrolactone and the like can be used separately or by mixing one or more of them. The concentration of the electrolyte dissolved into these solvents can be set to 0.5 to 2.0 mole/L.

In addition, the one in the solid state or the semi-solid state, which is made by evenly dispersing the above-described electrolyte to a high-polymerized matrix or impregnating the electrolyte in the non-aqueous solvent, can be used. As the high-polymerized matrix, polyethylene oxide, polypropylene oxide, polyacrylonitrile, polyvinylidene fluoride and the like can be used.

Further, for the purpose of preventing the short circuit of the positive electrode and the negative electrode, a separator can be provided. As a material for the separator, porous sheet, nonwoven fabric and the like, being made of polyethylene, polypropylene, cellulose or the like, are used.

The non-aqueous rechargeable battery according to this embodiment can be most preferably used for a vehicle such as EV, HEV and FCV. Since the above-described non-aqueous rechargeable battery can increase the energy density to 150 Wh/kg or higher, a driving range of the EV can be increased to about 300 km or longer in the same use condition as conventional. Considering that driving range of the conventional EV is about 200 km, the EV using the non-aqueous rechargeable battery according to this embodiment can remarkably increase its driving range, and can achieve the driving performance approximately equal to that of the conventional vehicle using the combustion engine.

Furthermore, by using the conventional battery external components with no modification, a high-power battery can be obtained without a large number of manufacturing steps and enormous expense.

### EXAMPLES

Hereinafter, Examples and Comparative examples of a cylindrical non-aqueous rechargeable battery of the present invention will be described.

### Fabrication of a Cylindrical Non-aqueous Rechargeable Battery

A positive electrode was fabricated in a manner as follows. Specifically, a positive electrode active material, acetylene black as a conductive material, N-methylpyrrolidone dilution of polyvinylidene fluoride as a binder material were mixed with each other, and the mixture thus obtained was coated on one surface of an aluminum foil. Thereafter, the aluminum foil was dried, and cut into pieces of a predetermined size. A mixing weight ratio of the positive electrode active material, conductive material and polyvinylidene fluoride was set to 90:5:5.

A negative electrode fabricated in a manner as follows was used. Specifically, a negative electrode material and N-methylpyrrolidone dilution of polyvinylidene fluoride as a binder were mixed, and coated on one surface of a copper foil. Thereafter, the foil thus obtained was dried and cut into pieces of a predetermined size. A mixing weight ratio of the active material and polyvinylidene fluoride was set to 90:10.

As the electrolytic solution, an electrolytic solution obtained by dissolving LiPF₆ into a non-aqueous solvent with the concentration of 1 mole/L was used. As the non-aqueous solvent in this case, a mixed solvent was used, which had a volume ratio of 1:1 between ethylene carbonate or propylene carbonate and dimethyl carbonate, depending on the negative electrode material to be used for an evaluation. As a separator, polypropylene film was used.

The device was fabricated by using the positive electrode and the negative electrode with the separator superposed therebetween, while making each of the surfaces having an active material coated thereon be faced to each other. This device was assembled into a predetermined evaluation cell, while equally held by the use of a spacer made of SUS, resulting in obtaining a sealed-type non-aqueous rechargeable battery cell. Also, the fabrication of the cell was carried out under an argon atmosphere where a dew point was suppressed to −60° C. or less.

### Example 1

Li_{0.8}MnO₂ having a capacity of 121 mAh/g was used as a positive electrode active material, and hard-graphitizable carbon having a capacity of 597 mAh/g and a reversible rate of the capacity (RN) of 81% was used as a negative electrode active material. In this case, a ratio between the positive electrode capacity and the negative electrode capacity ((CP·WP)/(CN·WN)) was set to 0.9. Then, a non-aqueous rechargeable battery was fabricated according to the above-described manufacturing method.

### Example 2

LiCoO₂ having a capacity of 132 mAh/g was used as a positive electrode active material, and hard-graphitizable carbon having a capacity of 522 mAh/g and a reversible rate of the capacity of 85% was used as a negative electrode active material. In this case, a ratio between the positive electrode capacity and the negative electrode capacity was set to 0.7. Then, a non-aqueous rechargeable battery was fabricated according to the above-described manufacturing method.

### Example 3

LiNiO₂ having a capacity of 155 mAh/g was used as a positive electrode active material, and hard-graphitizable carbon having a capacity of 337 mAh/g and a reversible rate of the capacity of 96% was used as a negative electrode active material. In this case, a ratio between the positive electrode capacity and the negative electrode capacity was set to 0.8. Then, a non-aqueous rechargeable battery was fabricated according to the above-described manufacturing method.

### Example 4

LiMnO₂ having a capacity of 153 mAh/g was used as a positive electrode active material, and hard-graphitizable carbon having a capacity of 546 mAh/g and a reversible rate of the capacity of 87% was used as a negative electrode active material. In this case, a ratio between the positive electrode capacity and the negative electrode capacity was set to 0.6. Then, a non-aqueous rechargeable battery was fabricated according to the above-described manufacturing method.

### Example 5

LiMn_{1.95}Al_{0.05}O₂ having a capacity of 183 mAh/g was used as a positive electrode active material, and hard-graphitizable carbon having a capacity of 546 mAh/g and a reversible rate of the capacity of 87% was used as a negative electrode active material. In this case, a ratio between the positive electrode capacity and the negative electrode capacity was set to 0.7. Then, a non-aqueous rechargeable battery was fabricated according to the above-described manufacturing method.

### Comparative Example 1

Li_{0.5}MnO₂ having a capacity of 121 mAh/g was used as a positive electrode active material, and hard-graphitizable carbon having a capacity of 546 mAh/g and a reversible rate of the capacity of 87% was used as a negative electrode active material. In this case, a ratio between the positive electrode capacity and the negative electrode capacity was set to 0.5. Then, a non-aqueous rechargeable battery was fabricated according to the above-described manufacturing method.

### Comparative Example 2

Li_{0.5}MnO₂ having a capacity of 121 mAh/g was used as a positive electrode active material, and hard-graphitizable carbon having a capacity of 527 mAh/g and a reversible rate of the capacity of 64% was used as a negative electrode active material. In this case, a ratio between the positive electrode capacity and the negative electrode capacity was set to 0.7. Then, a non-aqueous rechargeable battery was fabricated according to the above-described manufacturing method.

### Comparative Example 3

Li_{0.5}MnO₂ having a capacity of 121 mAh/g was used as a positive electrode active material, and graphitizable carbon having a capacity of 310 mAh/g and a reversible rate of the capacity of 96% was used as a negative electrode active material. In this case, a ratio between the positive electrode capacity and the negative electrode capacity was set to 0.7. Then, a non-aqueous rechargeable battery was fabricated according to the above-described manufacturing method.

### Comparative Example 4

LiCoO₂ having a capacity of 132 mAh/g was used as a positive electrode active material, and graphitizable carbon having a capacity of 353 mAh/g and a reversible rate of the capacity of 93% was used as a negative electrode active material. In this case, a ratio between the positive electrode capacity and the negative electrode capacity was set to 0.8. Then, a non-aqueous rechargeable battery was fabricated according to the above-described manufacturing method.

### Comparative Example 5

LiNiO₂ having a capacity of 155 mAh/g was used as a positive electrode active material, and graphitizable carbon having a capacity of 273 mAh/g and a reversible rate of the capacity of 94% was used as a negative electrode active material. In this case, a ratio between the positive electrode capacity and the negative electrode capacity was set to 0.6. Then, a non-aqueous rechargeable battery was fabricated according to the above-described manufacturing method.

### Evaluation

With using the sealed-type non-aqueous rechargeable battery cells fabricated according to Examples 1 to 5 and Comparative examples 1 to 5, the battery cells were repetitively charged/discharged at a voltage of 4.2 to 3.5 V and a constant current of 1 mA/cm² under an argon atmosphere in a room temperature. The discharge amount at the time of decrease behavior of the discharge amount being stabilized was obtained, and then an energy density was calculated based on a cell weight.

This result verified that the non-aqueous rechargeable batteries of the examples, which satisfied the conditions below, could obtain a high energy density of 150 wh/kg or higher and a lighter weight compared to the non-aqueous rechargeable batteries of the Comparative examples, which did not satisfy the conditions below. That was, a positive electrode having the active material capacity of 120 mAh/g or larger was used. A negative electrode having the active material capacity of 280 mAh/g or larger and the reversible rate of the capacity of 80% or more was used. The ratio between the positive electrode capacity and the negative electrode capacity was set to 0.6 to 0.9.

As described above, according to the non-aqueous rechargeable battery of the present invention, the ratio between the positive electrode capacity and the negative electrode capacity is taken so as not to have surplus or deficiency in the mutual capacities in a charge/discharge reaction. Also, the optimum combination between the capacity of the positive electrode active material and the capacity of the negative electrode active material is obtained, which makes it possible to obtain the maximum capacity per unit weight of the material, while considering the decrease of the battery capacity resulting from the irreversible capacity of the negative electrode itself. Hence, the capacity of the non-aqueous rechargeable battery can be made large to the maximum, while suppressing the weights of both active materials to the minimum necessary. In addition, in the case where the battery capacity is made constant, it becomes possible to reduce the battery weight necessary to obtain the energy. Therefore, a non-aqueous rechargeable battery having a light weight and a high energy density can be obtained, which is suitable to EV, HEV, FCV and the like.

The entire contents of Japanese Patent Application P2000-334529 (filled Nov. 1, 2000) are incorporated herein by reference.

Although the inventions have been described above by reference to certain embodiments of the inventions, the inventions are not limited to the embodiments described above. Modifications and variations of the embodiments described above will occur to those skilled in the art, in light of the above teachings.

The scope of the inventions is defined with reference to the following claims.

What is claimed is:

1) A non-aqueous rechargeable battery for a vehicle, comprising:
a positive electrode, which has a positive electrode active material having a capacity of 120 mAh/g or larger; and
a negative electrode, which has a negative electrode active material having a capacity of 280 mAh/g or larger and a reversible rate of the capacity of 80% or more,
wherein the ratio of the positive electrode capacity to the negative electrode capacity is set to 0.6 to 0.9.

2) The non-aqueous rechargeable battery according to claim 1,
wherein the capacity of the positive electrode active material is 120 mAh/g or larger, and the capacity of the negative electrode active material is in a range of 480 to 600 mAh/g.

3) The non-aqueous rechargeable battery according to claim 1,
wherein the capacity of the positive electrode active material is in a range of 120 to 160 mAh/g, and the capacity of the negative electrode active material is 400 mAh/g or larger.

4) The non-aqueous rechargeable battery according to claim 1,
wherein the positive electrode active material is complex oxide containing lithium metal.

5) The non-aqueous rechargeable battery according to claim 1,
wherein the complex oxide containing lithium metal is represented by a general formula below,
LiₓMO_{2-δ}
where M is one or more of metals selected from the group consisting of Co, Ni, Mn, Cr, Fe, V and Al, x is within a range of 0.4≦x≦1.1, and δ is within a range of 0≦δ≦0.1.

6) The non-aqueous rechargeable battery according to claim 1,
wherein the negative electrode active material is a carbon material.

7) The non-aqueous rechargeable battery according to claim 1,
wherein the carbon material is one or more of materials selected from the group consisting of coke, natural graphite, artificial graphite, hard-graphitizable carbon and low-temperature-baked carbon.

8) The non-aqueous rechargeable battery according to claim 1, further comprising:
a separator which is a sheet made of a polyolefine porous organic material;
and electrolyte containing lithium salt as electrolytic salt.

9) The non-aqueous rechargeable battery according to claim 1,
wherein the capacity of the positive electrode active material is 160 mAh/g or larger, and the capacity of the negative electrode active material is 280 mAh/g or larger.

10) The non-aqueous rechargeable battery according to claim 9,
wherein the capacity of the positive electrode active material is 160 mAh/g or larger, and the capacity of the negative electrode active material is in a range of 280 to 370 mAh/g.

11) The non-aqueous rechargeable battery according to claim 9,
wherein the positive electrode active material is complex oxide containing lithium metal.

12) The non-aqueous rechargeable battery according to claim 9,
wherein the complex oxide containing lithium metal is represented by a general formula below,
LiₓMO_{2-δ}
where M is one or more of metals selected from the group consisting of Co, Ni, Mn, Cr, Fe, V and Al, x is within a range of 0.4≦x≦1.1, and δ is within a range of 0≦δ≦0.1.

13) The non-aqueous rechargeable battery according to claim 9,
wherein the negative electrode active material is a carbon material.

14) The non-aqueous rechargeable battery according to claim 9,
wherein the carbon material is one or more of materials selected from the group consisting of coke, natural graphite, artificial graphite, hard-graphitizable carbon and low-temperature-baked carbon.

15) The non-aqueous rechargeable battery according to claim 9, further comprising:
a separator which is a sheet made of a polyolefine porous organic material;
and electrolyte containing lithium salt as electrolytic salt.
